(19) United States
(12) Patent Application Publication
(10) Pub. No.: US 2008/0016272 A1
(43) Pub. Date: Jan. 17, 2008

(54) METHOD OF REFRESHING DYNAMIC RANDOM ACCESS MEMORY, IN PARTICULAR IN STANDBY MODE AND IN ACTIVE OPERATING MODE, AND CORRESPONDING DYNAMIC RANDOM ACCESS MEMORY DEVICE, FOR EXAMPLE INCORPORATED INTO A CELLULAR MOBILE TELEPHONE

(75) Inventor: Michel HARRAND, Saint-Egreve (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Montrouge (FR)

(21) Appl. No.: 11/769,433

(22) Filed: Jun. 27, 2007

(30) Foreign Application Priority Data
Jul. 3, 2006 (FR) 0605990

(51) Int. Cl. G06F 12/00

(52) U.S. Cl. 711/106; 711/E12.08

(57) ABSTRACT

A dynamic random access memory may include at least one group of memory cells, and a respective auxiliary memory for each group of memory cells. The respective auxiliary memory is for storing refresh information specific to each respective group of memory cells. The refresh information may include a current refresh period and a time remaining before refresh.

### FIELD OF THE INVENTION

The invention relates to dynamic random access memories, that is to say, those using periodic refreshing of the data contained in the memory cells of these memories. More particularly, the invention relates to the refreshing of these dynamic random access memories and applies advantageously, but nonlimitingly, to cellular mobile telephones which incorporate dynamic random access memories.

### BACKGROUND OF THE INVENTION

Third-generation cellular mobile telephones may use the integration of large quantities of memory. However, the cost of the product should remain low. The use of dynamic random access memories, in place of the static random access memories, as will be appreciated by a person of ordinary skill in the art, allows this rise in memory capacity with low cost.

However, an important constraint in this type of application may be the finite electrical consumption while the telephone is on standby or in active operating mode, so as not to discharge the batteries too quickly. However, although dynamic random access memories have a smaller static leakage current than static random access memories, they need to be refreshed continuously, particularly, if the data has to be preserved in standby mode. This refreshing incurs energy consumption that may be important to minimize. The refresh frequency is given by the number of memory pages to be refreshed and by the retention time of the memory. This retention time may be related to the junction leakages of the transistors of the memory cells.

European patent application No. EP1647990, in the name of the Assignee of the present application, entitled “Procéde de rafraïchissement d'une mémoire vive dynamique et dispositif de mémoire vive dynamique correspondent, en particulier incorporé dans un telephone mobile cellulaire”, [Method of refreshing a dynamic random access memory, in particular in standby mode and in active operating mode, and corresponding dynamic random access memory device, in particular incorporated into a cellular mobile telephone] discloses an approach comprising continuously measuring the retention time of all the memory cells of the memory and tuning the refresh period accordingly. This application is incorporated in its entirety by reference. More specifically, so as to ascertain whether it is possible to decrease the refresh period, the method includes refreshing a chosen memory cell less often, and in looking at the number of errors caused by refreshing the data less frequently.

Furthermore, in the aforesaid application, on account of the incorporation into the dynamic memory of an error correcting system, consideration may only be given to a number of errors that is greater than the number of errors that could be corrected by the error correcting system per packet (or word) of memory cells, as a function of the ECC (“Error Correcting Code”) used. Indeed, an error correcting system may be capable of correcting a given number of errors within a packet of memory cells. However, though the method described above makes it possible to decrease the refresh frequency in the standby mode of the apparatus incorporating the dynamic memory, it may not be useable in the active operating mode of the apparatus.

Additionally, the method disclosed in the aforesaid application in the name of the Assignee of the present application, uses the same refresh frequency for the whole set of groups of memory cells, for example, the whole set of memory pages of the memory. Consequently, a single group of defective memory cells can influence the refresh frequency of the whole memory.

### SUMMARY OF THE INVENTION

An object of the invention is to provide a method of refreshing a dynamic random access memory, in which the small retention time of a memory cell has no or less effects on the refresh frequency of the other memory cells of the memory. Another object is to provide a method of refreshing a dynamic random access memory, in which it is possible to adapt the refreshing of the memory, and, hence, the power consumption related to this refreshing. Another object is to be able to adapt the refreshing of the memory even during the active operating mode of the apparatus incorporating random access memory.

According to a first aspect, a dynamic random access memory is provided and comprises groups of memory cells. According to a general characteristic of this first aspect, the memory comprises an auxiliary memory per group of cells for storing refresh information specific to the group of cells. Stated otherwise, the dynamic random access memory comprises an auxiliary memory which makes it possible to manage refresh information for each group of cells, independently of the others. Thus, each group of memory cells may benefit from its own refresh information; therefore, it is advantageously possible to modify this information without affecting the refresh information of the other groups of memory cells. The refresh information may comprise a current refresh period and a time remaining before refresh.

Consequently, it is possible, for example, to keep a relatively sizeable refresh period, but nevertheless allows for sufficient refreshing for a large part of the groups of memory cells and for a decrease in memory consumption. Additionally, for the groups of memory cells having a relatively small retention time, a smaller refresh period can be stored within the corresponding auxiliary memory.

Furthermore, by storing the time remaining before refresh, it is possible to ascertain the moment at which the next refresh may have to be performed. According to an embodiment, the refresh information furthermore comprises an indication of read access and an indication of write access. A logic circuit is able to update the access indications depending on whether the associated group of cells has been read accessed or write accessed in the course of a current refresh period. Stated otherwise, the refreshing of the groups of memory cells takes into account memory accesses, if any. Thus, for example, based on the refresh information and access indications, the pages that have recently been accessed do not need to be refreshed.

Indeed, accesses to the data being erased, a rewrite (and hence a refresh) of the data may take place systematically after each access. Consequently, the number of refreshes to be carried out per scan cycle may be limited, as explained in greater detail hereinafter, this bringing about a sizeable drop in memory consumption.

Moreover, given that this memory takes account of memory accesses, if any, it is possible to use it during active operation of the apparatus incorporating the memory. By reducing the frequency of refreshing in the active operating mode, the impact of the refreshing on the useful bandwidth may be reduced, that is to say, the number of memory accesses available to the user per unit time may be increased, thereby boosting the performance of the system. The memory as mentioned above can be incorporated into an apparatus having a standby mode and an active operating mode. This apparatus can form a component of a wireless communication system, for example, a cellular mobile telephone.

According to another aspect, a method of refreshing a memory as mentioned above is provided. According to a general characteristic of this other aspect, the method comprises scanning the auxiliary memories of the groups of cells while decrementing the time remaining, and if the time remaining is zero, refreshing the associated group of cells and reinitializing the time remaining to the value of the current refresh period.

According to another embodiment, the method furthermore comprises if a read access to the group of cells has taken place, increasing the time remaining associated therewith. Furthermore, the method may also comprise if a write access to the group of cells has taken place, reinitializing its current refresh period to a minimum value and canceling the time remaining associated therewith. The time remaining can be reinitialized to the current refresh period minus the period of the scan.

According to another embodiment, the method comprises the following steps forming part of a retention test (so as to determine the retention time of each group of memory cells): saving the content of a group of cells whose retention is tested in a temporary memory, increasing the associated time remaining, on expiry of the time remaining, comparing the content of the group of cells with the content of the temporary memory, if there is equality or a correctable difference (by virtue of an error correction system conventionally coupled to the random access memory), increasing the associated current refresh period, and if there is an uncorrectable difference, decreasing the associated current refresh period and restoring the content of the temporary memory into the tested group of cells.

Stated otherwise, the refresh period may be decreased when there is a risk of an uncorrectable error. The method furthermore may comprise if a write access has taken place during the retention test, reinitializing the current refresh period of the group of cells to a minimum value and canceling the time remaining associated therewith.

### BRIEF DESCRIPTION OF THE DRAWINGS

Other advantages and characteristics of the invention will become apparent on examining the detailed description of modes of implementation and embodiments, which is in no way limiting, and of the appended drawings, in which:

FIG. 1 schematically illustrates a random access memory according to the invention within which the memory cells are grouped together successively in rows,

FIG. 2 schematically illustrates in greater detail a memory device according to the invention, and more particularly, the auxiliary processing means or an auxiliary processor and the test means or a tester associated with the random access memory according to the invention, and

FIG. 3 illustrates a flowchart of a mode of implementation of the process according to the invention.

### DETAILED DESCRIPTION OF THE PREFERRED EMBODIMENTS

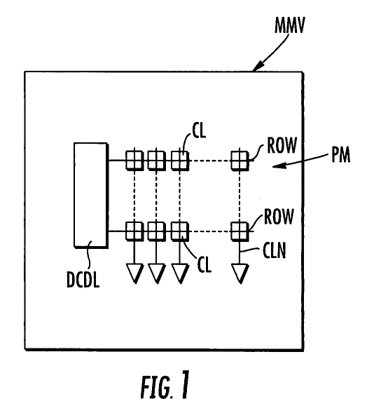

In FIG. 1, the reference MMV designates a dynamic random access memory whose memory plane PM comprises a matrix array of memory cells CL typically organized in rows (ROW) and columns (CLN). Each memory cell generally comprises a transistor and a capacitor. Additionally, as known by the person of ordinary skill in the art, the memory plane PM is connected to a row decoder DCDL and to a column decoder (not shown).

In a general manner, the retention time of all the cells of the memory are measured continuously and dynamically on the chip (integrated circuit) containing the memory MMV, and the refresh period of the memory cells of this memory may be adjusted accordingly. In the example described herein, the memory is organized into memory pages, a page corresponding to a line of words.

The major outlines of a mode of implementation of the method can be described now, before returning thereto in greater detail later. The addresses of the dynamic random access memory to be refreshed are continuously scanned at a scanning frequency, whether in standby mode or in active operating mode. In the course of the scan cycle, for each group of memory cells (in this example, a page), one detects whether an access has been performed by the user, during the previous scan period. Each group of memory cells (or each page) has its own refresh frequency; this frequency being a multiple of the memory scan frequency.

The refresh frequency for each page is determined with the aid of a retention test, a detailed mode of realization of which will be given hereinafter. In this example, it may be considered that the retention test takes account of the content of the memory page to determine its refresh frequency. A refresh of a memory page is deemed to be necessary if a duration corresponding to the refresh period for the page considered has expired.

If a read access has been carried out during the last scan period, then the refreshing of the page in question is delayed, by a duration equal to the latter's refresh period, less a scan period. Indeed, in a dynamic random access memory, the reading of the data is destructive, that is to say after reading a data item, the latter may be rewritten. Consequently, the reading of a data item is followed systematically by a refreshing of its value. It is not therefore usual to carry out an additional refreshing of the memory page just read.

In the case where the retention test takes account of the content of the page, if a write access has been performed by a user in the previous scan period, then the refresh frequency of the page considered is assigned its maximum value, and the refreshing of the memory page in question is delayed by a duration equal to its new refresh period less a scan period. Indeed, the data having just been written, it is not necessary to refresh it. However, the refresh frequency which was assigned to the page considered is no longer valid, given that the data stored by this page have changed. For safety, it is then considered that we have the worst case. Also, to avoid any data losses, the frequency of refreshing of the page considered is set to its maximum value.

More generally, if the retention test determines for a given page, a refresh period independent of its content, there is no need to distinguish a read access from a write access. In this case, if there is a memory access, regardless of the type of memory access, refreshing is delayed by the same duration, a duration that may be equal to the refresh period for the memory page, less a scan period.

On the other hand, if no user access has been detected during the previous scan period and if the refresh period has elapsed, the memory page in question is actually refreshed. Moreover, in parallel with the memory scan performed for the refreshing thereof, a test is performed on each page of memory cells, so as to tune its refresh frequency to an optimal value. For example, the test can consist for each page tested in not refreshing it for several periods and in then counting the errors that have appeared. If no error occurs, the refresh frequency of the page tested is decreased. Conversely, if errors occur, the refresh frequency of the memory page in question is altered.

Furthermore, as already mentioned hereinabove, an error correcting code (ECC) (for example, the Hamming code, known to the person of ordinary skill in the art) allows the correction of one bit per packet of memory cells. The error correcting code comprises additional bits added to each word during the writing thereof to the memory. These additional bits are processed when the word is read, so as to detect and correct a possible k errors per word (for example 1 error per word).

Consequently, during the retention test, it is possible to take account of the number of errors only if this number is greater than or equal to k within one and the same packet (word), k being the number of errors that can be corrected using the error correcting code. Indeed, if there are k or fewer errors within a packet (words) of memory cells, the latter may be corrected on account of the existence of the error correcting code. It is not therefore necessary to modify the refresh frequency to prevent the appearance of these errors. In the subsequent text, unless indicated otherwise, k is equal to 1. The test operation is repeated on the entire memory, changing test pages each time.

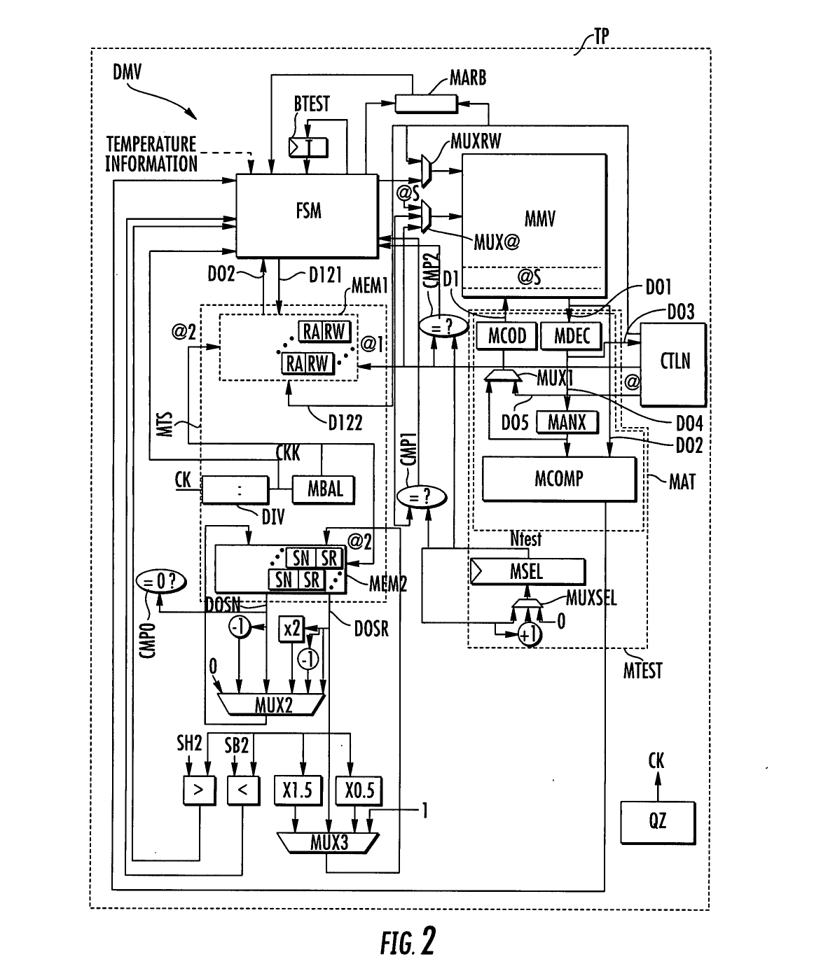

We now refer to FIG. 2, illustrating in greater detail a memory device referenced DMV. In order to implement the mechanism for refreshing the random access memory MMV and for regulating the refresh frequency, the memory device DMV comprises, in particular, in addition to the memory MMV, additional processing means or an additional processor MTS, an embodiment of which will now be described in greater detail.

The additional processor MTS comprises refreshing means or a refreshing component which are, in this example, formed by part of the control means or a controller FSM (represented outside the dashed line) able to control the refreshing of the memory MMV. To drive the refreshing of the memory MMV, the additional processor MTS comprises detection means or a detector MEM1 formed in this example by a preferably static memory of the dual-port type. The memory MEM1 is able to store as many words as pages contained in the memory MMV. Each word comprises, in particular, two access indication bits RA and RW, able respectively to indicate the occurrence of a read access (RA=“1”) and a write access (RW=“1”).

The memory MEM1 is connected to the controller FSM by way of two busses: an output bus DO2 and an input bus DI21. The bus DO0 makes it possible to deliver, for a memory page considered, the value of the bits RA and RW. The address of the memory page to be considered is delivered to the memory MEM1, via an address bus @2. The memory MEM1 is also connected to a conventional driver CTLN dedicated to the active operation of the device DMV. When a user access occurs during active operation, the driver CTLN sends the new values of the bits RA and RW to the memory MEM1 via a data bus DI22 together with the address of the page accessed by an address bus @1.

The additional processor MTS also comprise scan means or a scanner MBAL which receive a clock signal CK, divided by a divider DIV, so that the signal CKK delivered to the input of the scanner has the scan frequency as its frequency. Thus, on the basis of the signal CKK and of the total number Nmax of memory pages of the memory MMV, the scanner MBAL successively delivers the addresses of the memory pages of the memory, via the bus @2. The clock signal CK is, for example, generated by a quartz oscillator QZ.

The additional processor MTS also comprises delay means or a buffer comprising in this example, a memory MEM2 of static memory type, which may be single-port. In another embodiment, it would be possible to group the memories MEM1 and MEM2 together in a single dual-port memory. Just as for the memory MEM1, the memory MEM2 comprises as many words as pages in the memory MMV. Each word of the memory MEM2 comprises, in particular, two items of refresh information SN and SR. The item SR indicates the current value of the refresh period of a given page. Thus, each word of the memory MEM2 corresponds to an auxiliary memory mentioned hereinabove.

The item SN indicates the time remaining before the next refresh of the page considered. This time remaining is expressed as a function of a reference time unit, this reference time corresponding, for example, to the scan period. The memory MEM2 is connected to the scanner MBAL by way of the address bus @2, so as to receive the address of the designated memory page for each scan cycle.

Additionally, the value of the item SN is delivered as output from the memory MEM2 via an output bus DOSN to a comparator CMP0. If the value of SN is zero, then the comparator CMP0 delivers an item of information to the controller FSM, so as to refresh the page at the address designated by the scanner MBAL. When a memory page of the memory MMV is to be refreshed, the controller FSM delivers a command for refreshing at the address of the page to be refreshed to the memory MMV, respectively via a multiplexer MUXRW and a multiplexer MUX@.

If a user access takes place, the driver CTLN sends the address of the accessed page, the read or write command, and the data to be written (in the case of a write), respectively via the multiplexers MUX@, MUXRW, and MUX1. Additionally, the random access memory device DMV comprises a tester MTEST, so as to optimize the refresh frequency of each memory page of the memory. An embodiment of the tester MTEST is described in greater detail in the aforesaid application in the name of the Assignee of the present application.

This embodiment is represented in FIG. 2. However, it is possible to deploy any other embodiment compatible with the dynamic random access memory device, for example, the tester disclosed in the aforesaid application in the name of the Assignee of the present application.

In this example, the mode of implementation deployed by the tester MTEST consists in refreshing less quickly, for example, half as quickly as the remaining pages, a selected memory page dubbed the test page, and observing whether or not this causes errors. The operation is repeated on the entire memory, changing test page each time. The appearance of errors in the content that is not refreshed for two periods, indicates that the value of the refresh frequency is too small.

More precisely, before refreshing a test page less quickly, a model content of the test page is devised. To do this, the content of the test page is saved in a reserved part of the random access memory or in an ancillary static memory, for a latency period, and it is refreshed at the maximum refresh frequency. In this way, errors related to junction leaks are prevented. To do this, the tester MTEST comprises a selector MSEL which scans each page of the memory successively and cyclically, so as to test each memory page of the memory MMV one by one. They then deliver an address Ntest of a selected memory page, stated otherwise, a test page.

The selector MSEL is controlled by the controller FSM by way of a multiplexer MUXSEL connected to their input. According to the command of the controller FSM, the selector MSEL may be either reset to zero, or incremented by one unit, or maintained at their present value. A test page is not refreshed by the controller FSM. Accordingly, the device DMV comprises a comparator CMP1 that receives as input the addresses delivered on the bus @2 and Ntest. If the two addresses correspond, the controller FSM passes the refreshing of the memory page.

The retention time of the memory cells of the selected test page is tested by the tester MTEST, under the proviso of a write access of the test page, as will be described hereinafter. The tester MTEST comprises a decoder MDEC (forming an error correcting system) connected to the output of the random access memory MMV by way of an output bus DO1. The decoder MDEC makes it possible to correct any errors in the data of the memory by using additional bits constituting the error correcting code deployed within the memory device as mentioned hereinabove. The decoder MDEC processes the data delivered by the bus DO1.

In this example, it is considered that the model content of the test page is saved in a reserved part of the memory MMV (or temporary memory), with address @S, that the user is not entitled to use. The reserved part of the memory MMV, with address @S, serves to save the model content of the test page, as was described hereinabove. The reserved part with address @S of the memory may, for example, be refreshed at the maximum refresh frequency, or may be refreshed at its own refresh frequency but with priority testing.

The output of the decoder MDEC is linked to a register MANX by way of a bus D04. The register MANX is controlled by the controller FSM. The register MANX receives the test page saved word-by-word, so as to be able to perform the comparison with the tested word, refreshed at a lower frequency.

As a variant, the size of the register MANX can be adapted to be able to receive several words (or the entire test page saved), especially in the case where reading is performed according to the so-called “Burst” mode, that is to say when several words of one and the same page are read in succession.

The output of the register MANX is connected to bitwise comparator MCOMP. The latter also receives in parallel the data of the test page that is not refreshed during the latency period, which data is delivered directly as output by the memory MMV via the bus DO1. (By way of example, detailed embodiments of the comparator are described in the aforesaid application in the name of the Assignee of the present application). The comparison may also be carried out in “Burst” mode.

The bitwise comparator MCOMP compares the content of the register MANX, that is to say, the model memory page, and the data delivered by the bus DO1, that is to say, the data that is not corrected and not refreshed during the latency period, of the corresponding memory page. If the comparator MCOMP (forming tagging means) tags at most 1 bit having a different value between the model content and the unrefreshed content (i bits in the general case, with i≦k, if the corrector code deployed in the system can correct k errors), the value is disregarded, since the decoder MDEC may be able to correct it (with the aid of the corrector code added to the data) when the data of the memory page in question are delivered from the memory.

The controller FSM then instructs a slight decrease in the refresh frequency of the test page. On the other hand, if there is more than one error, the controller FSM then instructs a slight increase in the refresh frequency of the test page. To drive the refresh frequency, the controller FSM drives a multiplexer MUX3 connected by a bus DOSR to the memory MEM2 and whose output is looped back to the memory MEM2.

The multiplexer MUX3 receives as input the current value of SR, its minimum value (“1”), its increased value (here multiplied by 1.5) and its decreased value (here multiplied by 0.5). If the refresh period is to be decreased, the controller FSM instructs the delivery of the current value of SR multiplied by 0.5 (this value is given by way of indication). If the refresh period is to be increased, the controller FSM instructs the delivery of the current value of SR multiplied by 1.5 (this value is given by way of indication). If the refresh frequency is unchanged, the controller FSM instructs the delivery of the current value of SR.

Additionally, the value of SR may lie between two thresholds, respectively low SB2 and high SH2. To do this, the value of SR is delivered to two comparators, comparing it respectively with each of its thresholds. The output of these two comparators is connected to the controller FSM which regulates the value of SR, if the latter no longer lies in the range allocated to it.

This embodiment is given by way of illustration. For example, instead of multiplying the refresh frequency by a constant, it is possible to add or to deduct a value to increase or decrease the refresh frequency. Additionally, the controller FSM controls a multiplexer MUX2, connected by a data bus DOSN to the memory MEM2, and whose output is looped back to the input of the memory MEN2. By controlling the multiplexer MUX2, the controller FSM tunes the value of the item SN so as to trigger the refresh at the appropriate moment.

The controller FSM may thus decrement, reset to its initial value, or assign the value of the latency period or its minimum value, to the item SN. For this purpose, the multiplexer MUX2 receives, as input, the current value of the item SN via the data bus DOSN. The value of SN is decremented by one unit at each scan cycle of the memory MMV, the value of 0 so as to force the item SN to its minimum value in order to cause a refresh at the next scan cycle of the memory, a value equal to twice the item SR so as not to refresh the memory page undergoing testing during a latency period equal, in this example, to twice the value of SR. The value of SR is decremented by one unit, SR-1, in the case where a read access has been effected by the user during the previous scan cycle and directly the item SR when one wishes to reinitialize the item SN to the current value of the refresh period of the memory page considered.

The output of the memory MEM2 is connected to the comparator CMP0 via the bus DOSN to verify whether the value of SN is zero, as detailed hereinabove. Moreover, the driver CTLN is connected to the decoder MDEC via the bus DO3, when data are read in the active operating mode. Thus, when a data item is read, any error therein is detected and corrected by the decoder MDEC. Additionally, during active operation, the driver CTLN delivers via a bus DO5, the data to be written to the memory via a multiplexer MUX1 connected at the input of the coder MCOD.

The multiplexer MUX1 is also connected to the output of the register MANX so as to receive the model memory page arising from the comparison performed by the comparator MCOMP, replacing the test page which has not been refreshed during a latency period and which may therefore have errors. The multiplexer MUX1 is controlled by the controller FSM, so as to deliver, either the model memory page which is to be rewritten to the memory MMV, or the data to be written during a user access.

The data delivered by the multiplexer MUX1 are encoded by the coder MCOD before being written to the memory MMV. Thus, the coder MCOD generates additional bits constituting the corrector code for each word delivered by the multiplexer MUX1 and then written to the memory MMV. As a variant, it is possible to write to the memory only the words where the comparator MCOMP has detected at least one error.

The memory device also comprises a comparator CMP2, connected at the output of the driver CTLN and selector MSEL. If the address Ntest of the memory page undergoing testing is accessed by the user, a signal is delivered by the comparator CMP2 to the controller FSM. The controller FSM may then force the user access to the reserved area of address @S of the memory MMV, which stores the model memory page and not the content of the memory page undergoing testing. To do this, the multiplexer MUX@ comprises an input to which the address @S of the reserved area is delivered.

Furthermore, the device DMV comprises arbitration means or a arbitrator MARB, an input of which is connected to the controller FSM and another input of which is connected to the driver CTLN dedicated to active operation. The arbitration means MARB make it possible to order the refreshing and the user access according to a chosen priority. The arbitration means MARB may authorize the refreshing of the memory page and may permit user access, after a standby time (“wait state”).

For this purpose, depending on the information items delivered by the arbitration means MARB, the controller FSM can command the multiplexers MUX@, MUXRW, and MUX1 in such a way as to send the address, the command, and the data item originating from the driver CTLN or the refresh system according to a chosen priority. The controller FSM also receives as input the temperature item, so as to force the increasing of the refresh frequency of each memory page in the event of a very fast variation in temperature. This item of information comprises an indication of fast variation of temperature, and makes it possible to anticipate data losses resulting from a fast rise in temperature. Additionally, in order to indicate whether a page of the memory is being tested, a toggle BTEST looped back to the controller FSM stores a variable T taking the value “1” if the page indicated by the selector MSEL is currently being tested.

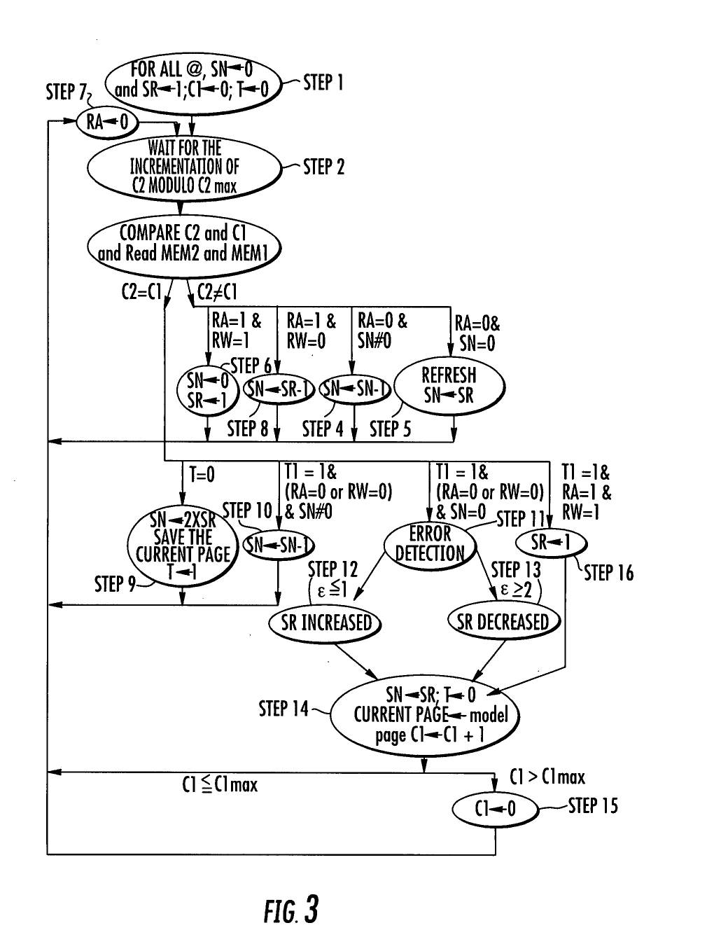

We now refer more particularly to FIG. 3, which represents a flowchart describing the various states of the controller FSM which may be embodied in the form of a finite state machine. In FIG. 3, the references C1 and C2 denote the addresses delivered respectively by the selector MSEL and the scanner MBAL. The variable T indicates whether the test of the test page considered is in progress: in this case T=“1”.

During a first initialization step, the items SN and SR are set respectively to “0” and “1”, so as to assign by default the maximum refresh frequency (SR=1), and to cause a refresh right from the first scan cycle (SN=0). Furthermore, the counter C1 is initialized, as is the variable T (step 1; for all the @, SN<-0 and SR<-2; C1<-0, and T<-0). The value of the counter C2 is for its part managed by the divider DIV.

In the course of a second step, we wait for the incrementing of the counter C2 (modulo C2max) so as to designate the first memory page to be processed of the memory MMV (more generally so as to designate a determined page of the memory) (step 2, “wait for the incrementing of C2 modulo C2max”). The values of the counter C2 and of the counter C1 are then compared and the content of the memories MEM2 and MEM1 is read (step 3; comparison C2 and C1 and read MEM2 and MEM1).

If the address designated by the counter C2 is different from that designated by the counter C1 (C2≠C1), then the value of the items SN, RA and RW is studied. If RA is equal to 0, and SN is different from 0, no refreshing of the memory page designated by the counter C2 is carried out, and the item SN is decremented by one unit (step 4; SN←SN-1). Next, steps 2 to 4 are repeated so long as SN is different from 0 and that RA remains at 0.

When SN is zero (RA still being equal to 0), the refreshing of the memory page in question is carried out and SN is reassigned its current maximum value (step 5; refresh, SN<-SR). If the bits RA and RW are equal to “1”, this signifies that there has been a memory access by the user, and that this access was a write access.

In the course of a step 6, SR is then assigned its minimum value and SN is assigned the value of SR less 1 (that is to say 0 in this case), so as to prevent the case where the write access has taken place at the very start of the period (SN←0; SR←1). Stated otherwise, the memory page in question is assigned a minimum refresh period (SR←1), since it is surmised that the new data written to the memory page correspond to the worst cases, that is to say that all the memory cells have a minimum retention time, and that they may save a bit equal to “1”.

By assigning the value 0 to the variable SN, a refresh of the memory page can be performed at the next scan cycle. On completion of step 6, RA is reset to “0” (step 7; RA<-0), and we transfer to step 2. In this example, step 7 is also implemented after steps 4 and 5, but it has no influence since RA is already equal to 0 after each of these two steps. If the variables RA and RW indicate that there has been a read access (RA=1 & RW=0), then the variable SN is assigned the value of SR less an interval, since the access may have taken place at the very start of the period (SN←SR-1; step 8). Indeed, since reading is destructive, all the data have been rewritten on completion of this read, thereby rendering the refresh unnecessary.

On completion of step 8, we move again to step 2, via step 7 where RA is reset to 0. If, on completion of step 3, the address designated by the counter C2 corresponds to the address designated by the address of the counter C1 (C2=C1), then the value of the variable T is studied. If the variable T is equal to 0, signifying that the test of the memory page considered has not yet begun, then the test is commenced, by assigning the value of the latency period to the variable SN, in this example twice the value of the variable SR, and the value 1 to the variable T. The test page is saved: this is the model page for the corresponding test page (SN←2.SR, save of the current page, T←1, step 9).

On completion of step 9, we again move to step 2, via step 7. If, on completion of step 3, the address designated by C2 corresponds to the address designated by C1, and the variable T is equal to 1, no user write access having taken place (RA=0 or RW=0) and should the variable SN be different from 0, then SN is decremented without carrying out the refresh, so as not to disturb the test phase in progress (SN←SN-1; step 10). No account is taken of the memory read accesses that may have taken place during the latency period: indeed, these accesses are redirected towards the backup page saved in the ancillary memory, and therefore do not refresh the page currently being tested.

On the other hand, if SN is 0, indicating that the latency period has elapsed, then in the course of a step 11 we carry out the detection of the errors between the model content and the unrefreshed content of the memory page undergoing testing, as explained hereinabove. If the maximum number of errors per word (ε) is less than or equal to 1 (ε≦1), then the refresh period of the page considered is increased (step 12; SR increased). If there is more than one error in at least one word of the test page (ε≧2), then the refresh period of the page considered is decreased (step 13, SR decreased).

Next, the variable T is reset to zero, the variable SN is reset to its maximum value, the value of the model page is loaded into the current page of the memory MMV, and the counter C1 is incremented (step 14; SN←SR; T<-0, current page <- model page, C1←C1+1). If the address of the test page was not the last address of the memory (C1≦C1max), we transfer to step 2, via step 7. If the address of the test page was the last address of the memory, (C1>C1max), then C1 is reinitialized (step 15; C1<-0) and we then transfer back to step 2, via step 7.

When, on completion of step 3, the address designated by C2 corresponds to the address designated by C1, and if in the course of the test period a write access has taken place during the previous scan period (T=1 and RA=R1 and RW=1), then, in the course of a step 16, a test of the page considered is denied and SR is assigned its maximum value (SR<-1). We then return to step 14.

This is particularly beneficial in the case where the memory is used in a uniform manner at high or moderate frequency which is however sufficiently fast for the retention test means not to be able to operate effectively. The refresh system can then hardly intervene at all. In the case where the memory is accessed at low frequency, there is a strong chance that only a small part of the memory can be used. In this case, the unused part can be set progressively to the minimum refresh frequency enabling data retention. Only the used part of the memory can always be refreshed, and out of the latter, only the pages which are not used frequently can be so at maximum frequency.

1-9. (canceled)

10. A dynamic random access memory comprising:
a plurality of groups of memory cells; and
a respective auxiliary memory for each group of memory cells for storing refresh information specific thereto.

11. The dynamic random access memory according to claim 10 wherein the refresh information comprises a current refresh period and a time remaining before refresh.

12. The dynamic random access memory according to claim 11 wherein the refresh information further comprises an indication of read access, and an indication of write access.

13. The dynamic random access memory according to claim 12 further comprising a logic circuit for updating said respective indication of read access and said respective indication of write access depending on whether said respective group of memory cells has been read accessed or write accessed during a current refresh period.

14. A electronic device comprising:
a plurality of groups of dynamic random access memory cells;
an respective auxiliary memory for each groups of dynamic random access memory cells for storing refresh information specific thereto; and
a logic circuit for updating the refresh information depending on whether said respective groups of dynamic random access memory cells has been read accessed or write accessed during a current refresh period.

15. The electronic device according to claim 14 wherein the refresh information comprises the current refresh period, a time remaining before refresh, an indication of read access, and an indication of write access.

16. The electronic device according to claim 15 wherein said logic circuit is for updating said indication of read access and said indication of write access depending on whether said respective groups of dynamic random access memory cells has been read accessed or write accessed during the current refresh period.

17. The electronic device according to claim 14 wherein the electronic device has an active operating mode and a standby mode.

18. The electronic device according to claim 14 wherein the electronic device is a cellular communications device.

19. A method of refreshing a dynamic random access memory comprising a plurality of groups of memory cells, a respective auxiliary memory for each group of memory cells for storing refresh information specific to the respective group of memory cells, and a logic circuit for updating, the refresh information comprising a current refresh period, a time remaining before refresh, an indication of read access, and an indication of write access, the indications updated by the logic circuit depending on whether the respective group of memory cells has been read accessed or write accessed during the current refresh period, the method comprising:
scanning each respective auxiliary memory while decrementing the time remaining before refresh; and
refreshing, if the time remaining before refresh is zero, each group of memory cells and reinitializing the time remaining before refresh to a value of the current refresh period.

20. The method of refreshing a dynamic random access memory according to claim 19 further comprising, if a read access to the group of cells has taken place, increasing the respective time remaining before refresh associated therewith.

21. The method of refreshing a dynamic random access memory according to claim 19 further comprising, if a write access to the group of cells has taken place, reinitializing its respective current refresh period to a minimum value and canceling the respective time remaining before refresh associated therewith.

22. The method of refreshing a dynamic random access memory according to claim 20 wherein the respective time remaining before refresh is reinitialized to the respective current refresh period minus a period of the scan.

23. The method of refreshing a dynamic random access memory according to claim 19 further comprising performing a retention test on a group of memory cells from the plurality of groups of memory cells by at least:
saving a content of the tested group of memory cells in a temporary memory;
increasing the respective time remaining before refresh for the tested group of memory cells; and
on expiration of the respective time remaining before refresh for the tested group of memory cells, comparing the content of the tested group of memory cells with a content of the temporary memory;
if there is equality or a correctable difference, increasing the respective current refresh period for the tested group of memory cells; and
if there is an uncorrectable difference, decreasing the respective current refresh period for the tested group of memory cells and restoring the content of the temporary memory into the tested group of memory cells.

24. The method of refreshing a dynamic random access memory according to claim 23 further comprising, if a write access has taken place during the retention test, reinitializing the respective current refresh period for the tested group of memory cells to a minimum value and canceling the time remaining before refresh associated therewith.

25. A method of operating a dynamic random access memory comprising a plurality of groups of memory cells, and a respective auxiliary memory for each group of memory cells, the method comprising:
storing refresh information specific to each group of memory in the respective auxiliary memory.

26. The method of operating a dynamic random access memory according to claim 25 further comprising:
scanning each respective auxiliary memory while updating the respective refresh information stored therein; and
refreshing each group of memory cells based upon the respective refresh information.

27. The method of operating a dynamic random access memory according to claim 25 wherein the refresh information comprises a time remaining before refresh and a current refresh period; and further comprising performing a retention test on a group of memory cells from the plurality of groups of memory cells by at least:
saving a content of the tested group of memory cells in a temporary memory;
increasing the respective time remaining before refresh for the tested group of memory cells; and
on expiration of the respective time remaining before refresh for the tested group of memory cells, comparing the content of the tested group of memory cells with a content of the temporary memory;
if there is equality or a correctable difference, increasing the respective current refresh period for the tested group of memory cells; and
if there is an uncorrectable difference, decreasing the respective current refresh period for the tested group of memory cells and restoring the content of the temporary memory into the tested group of memory cells.

28. The method of operating a dynamic random access memory according to claim 27 further comprising, if a write access has taken place during the retention test, reinitializing the respective current refresh period for the tested group of memory cells to a minimum value and canceling the time remaining before refresh associated therewith.
